(19) United States
(12) Patent Application Publication
(10) Pub. No.: US 2024/0130540 A1
(43) Pub. Date: Apr. 25, 2024

(54) LIGHTING APPARATUS FOR A MERCHANDIZER ID CHANNEL

(71) Applicant: LIGHTING FOR IMPACT, LLC, LINCOLN, NE (US)

(72) Inventors: Chad C Essink, Lincoln, NE (US); Kirk R Lewis, Lincoln, NE (US)

(73) Assignee: LIGHTING FOR IMPACT, LLC, LINCOLN, NE (US)

(21) Appl. No.: 18/321,130

(22) Filed: May 21, 2023

Related U.S. Application Data
(60) Provisional application No. 63/380,198, filed on Oct. 19, 2022.

(51) Int. Cl. A47F 5/00; F21S 4/28; F21V 21/088

(52) U.S. Cl. CPC A47F 5/0068; F21S 4/28; F21V 21/088; F21Y 2115/10

(57) ABSTRACT

A lighting apparatus for a merchandizer shelf having ID-channels has an aft arm for interfacing with the shelf and contact points to interface with the upper and lower ridges of the ID-channel. Aft positioned light sources provide illumination to product located above and below the apparatus on the merchandizer and the apparatus may also provide a substitute ID-channel in place of the ID-channel it occupies.

### CROSS-REFERENCES TO RELATED APPLICATIONS

The present invention claims priority to prior filed U.S. Application No. 63/380,198 filed on Oct. 19, 2022 and titled “ENHANCED MOUNTING ASSEMBLY FOR RETAIL LIGHTING,” and incorporates the same by reference herein in its entirety.

### FIELD OF THE INVENTION

The present invention relates to the field of merchandising and more particularly relates to an ID-channel attachment for merchandisers which incorporates lighting and an added attachment feature.

### BACKGROUND OF THE INVENTION

The process of buying and selling is a cornerstone of a capitalistic society. It is also well known that the presentation of goods sold can affect not only a customer's opinion of the goods, but also can provide more information to a potential customer before purchase. To this end, merchandizers are manufactured to hold and display goods offered for sale. While some merchandisers may be specifically designed for a given product, the most common merchandiser is the humble shelf. Shelves provide support and organization for many diverse types of goods and provide an orderly presentation of the goods for sale. One common feature on most shelves, and in other types of merchandisers, is the presence of a front, concave surface called an ID-channel. This ID-channel is a specialized area of a merchandiser set in front of the space which holds an allotted product which may be used to hold tags which provide information about the product assigned to that space, including price. The tags are usually slid or bent to fit between two opposed upper and lower rims of the ID-channel or may be fitted into specialized holders which are similarly affixed to the ID-channel.

Improvements can be made to merchandisers, including shelves. One of the more effective improvements is the addition of lighting. Lighting allows the product to be better seen, particularly as upper shelves tend to cast shadows on lower ones. However, positioning lighting in a manner to illuminate product over the length of a merchandiser shelf can be problematic. To this end, lighting solutions which mount in the ID channel have been developed. However, these tend to require a selectable mounting system which can be unfastened unintentionally and take additional time to mount and unmount due to the use of specialty tools. What is needed is a more efficient way to provide an ID-channel lighting solution.

The present invention is a lighting apparatus which slips over the ID-channel of a shelf merchandiser. The lighting apparatus will then be pivoted upwards and anchored with a specialized arm to hold the lighting apparatus securely in the ID-channel. The apparatus provides lights and an auxiliary ID-channel for the positioning of price tags and other indicia. The present invention represents a departure from the prior art in that the lighting of the present invention allows for the one-step toolless mounting and unmounting of a lighting apparatus on a merchandiser ID-channel.

### SUMMARY OF THE INVENTION

In view of the foregoing disadvantages inherent in the known types of merchandiser lighting solutions, an improved ID-channel mounted lighting structure may provide a clip-on interface that meets the following objectives: that it be easy to install and uninstall without the need for tools, that it effectively illuminates the shelves above and below the apparatus, and that it be easy and economical to manufacture. As such, a new and improved lighting fixture may comprise an extruded base with opposed light mounting slots, mounting contact points, and an aft located support arm to interface with the merchandiser shelves to accomplish these objectives.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in several ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the way the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of one embodiment of the lighting apparatus mounted upon a merchandizer shelf.

FIG. 2 is an exploded view of the lighting apparatus and merchandizer shelf of FIG. 1.

FIG. 3 is a truncated perspective view of the lighting apparatus of FIG. 1.

FIG. 4 is a truncated front elevation of the lighting apparatus of FIG. 1.

FIG. 5 is a truncated top plan view of the lighting apparatus of FIG. 1.

FIG. 6 is an enlarged side elevation of the lighting apparatus of FIG. 1.

FIG. 7 is a sectional view of the lighting apparatus of FIG. 4, taken along line VII-VII and mounted upon a merchandiser shelf.

FIG. 8 is the sectional view of the lighting apparatus of FIG. 7 having had the end cap removed.

FIG. 9 is a side elevation of the lighting apparatus and shelf of FIG. 1, in partial transparency, the lighting apparatus positioned for mounting upon the merchandizer shelf.

FIG. 10 is a side elevation of the lighting apparatus and merchandizer shelf of FIG. 9, the lighting apparatus in an intermediate mounting position.

FIG. 11 is a side elevation of the lighting apparatus and merchandizer shelf of FIG. 9, the lighting apparatus in a mounted position.

### LIST OF REFERENCE NUMERALS

100—an exemplary lighting apparatus;
110—extrusion channel;
111—substitute ID-channel;
113—upper contact point;
115—spring arm;
117—lower contact point;
119—screw mount;
120—upper LED light strip;
122—upper lighting trough;
130—lower LED light strip;
132—lower lighting trough;
140—end cap;
143—end cap upper contact point;
147—end cap lower contact point;
150—end cap mounting screw;
200—merchandiser shelf;
211—forward edge of shelf;
213—upper ID-channel groove;
215—ID-channel wall;
217—lower ID-channel ridge;
219—shelf side forward edge.

### DESCRIPTION OF THE PREFERRED EMBODIMENT

With reference now to the drawings, a preferred embodiment of the lighting apparatus for merchandizer ID-channels is herein described. It should be noted that the articles “a,” “an,” and “the,” as used in this specification, include plural referents unless the content clearly dictates otherwise.

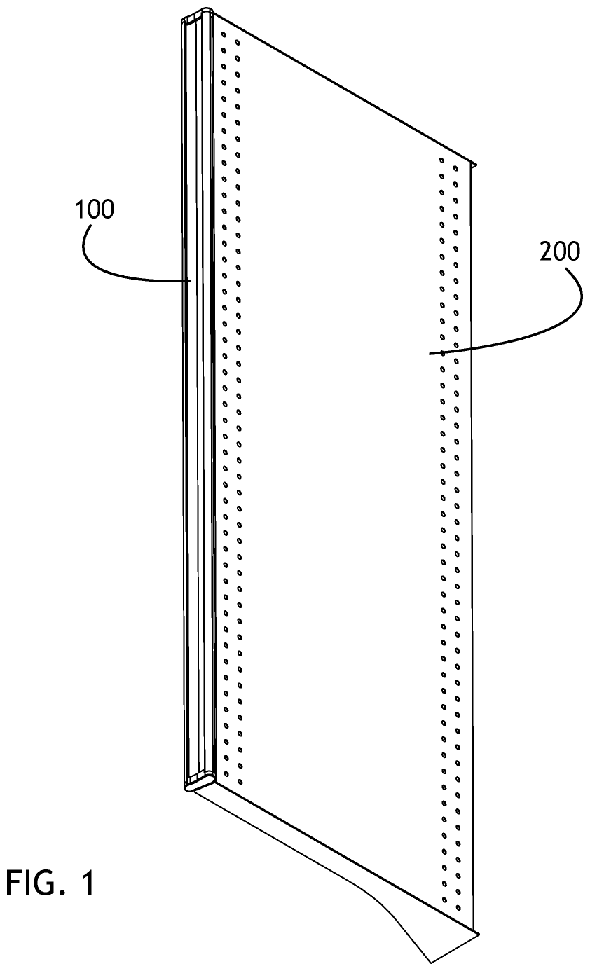

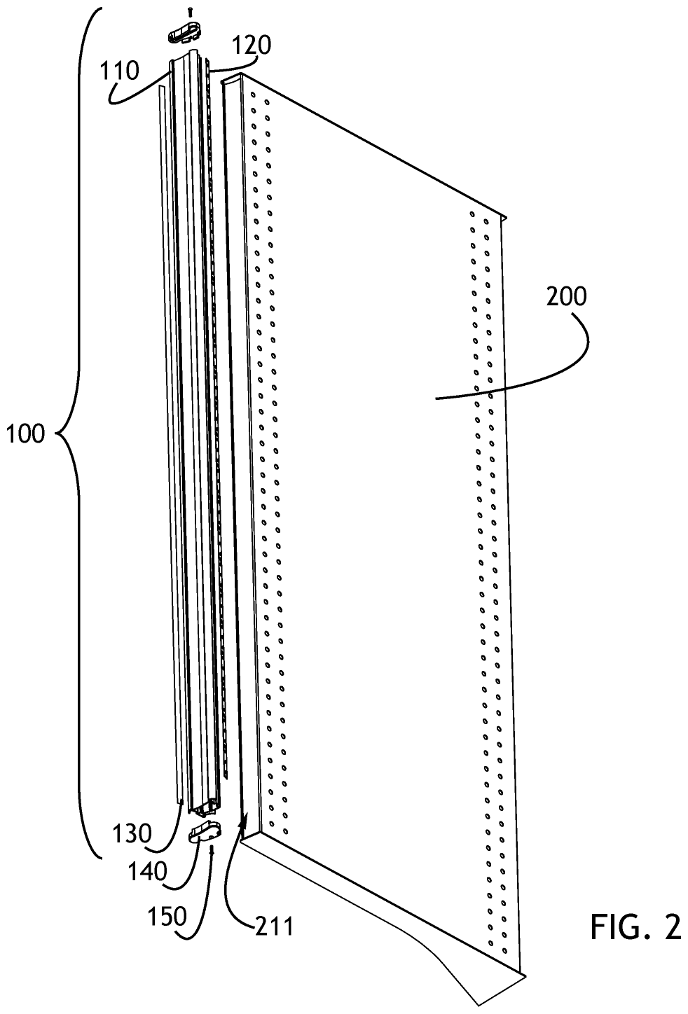

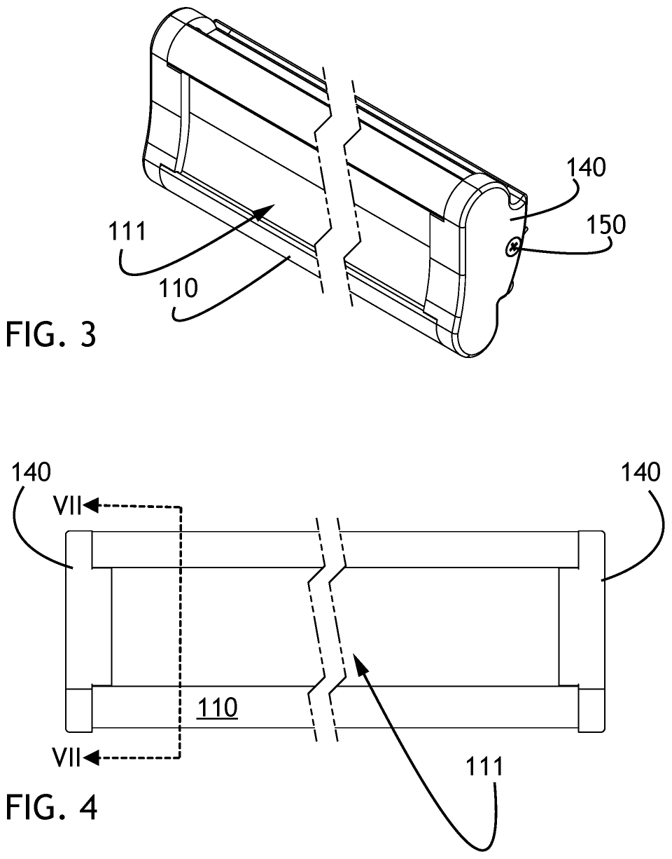

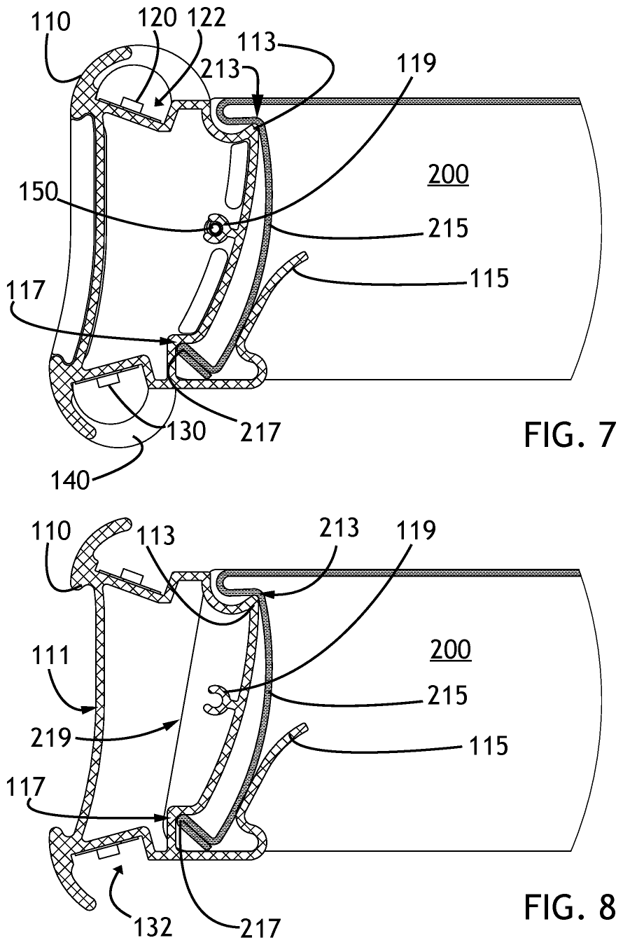

With reference to FIGS. 1-4, a merchandizer shelf 200 may be fitted with a lighting apparatus 100 over the shelf's front edge 211. The lighting apparatus 100 may be constructed with an extrusion channel 110 with upper and lower rearward angled troughs 122, 132 (FIGS. 7 and 8) which will hold two light sources 120, 130 to illuminate product positioned on the shelf and on a lower shelf. A substitute ID-channel 111 is then provided to function like the ID-channel taken up by the apparatus 110, which is to say to hold tags displaying pricing and other product information proximate the product's location on the shelf.

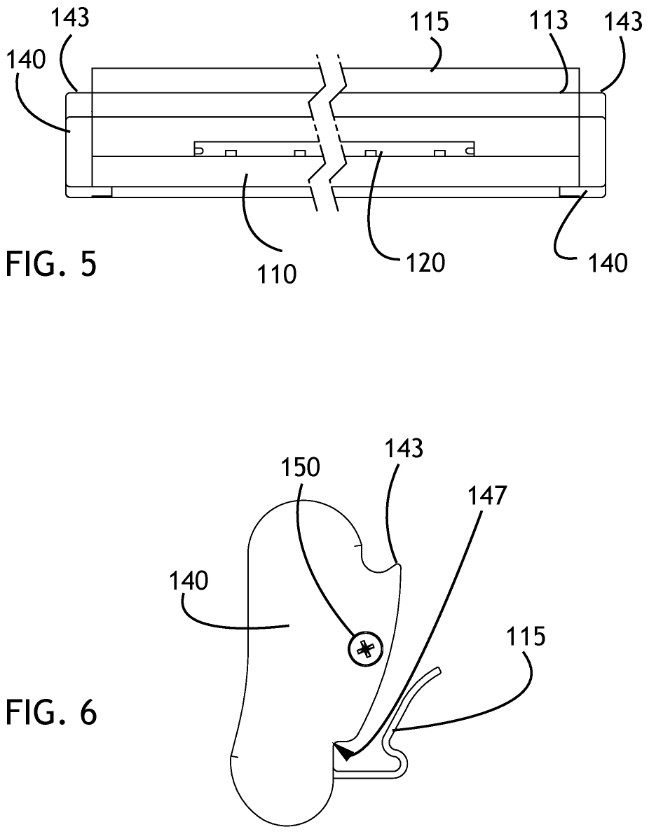

With reference to FIGS. 5-8, the extrusion channel 110 serves as the main structure of the apparatus, providing two rearward facing, angled troughs for light sources 120, 130, such as the illustrated LED strips, and are covered with ends caps 140 for a complete finish. A prominent fin or “spring arm” 115 is located on an aft portion of the extrusion channel 110. Extrusion channel 110 also presents two contact points 113, 117 (which are matched on end caps with support points 143, 147) that are designed to interface with the upper and lower edges of an ID-channel of the merchandiser shelf while the aft spring arm 115 reaches behind the ID-channel to secure the apparatus. Of note, contact point 113 (and end cap contact point 143) is a positive spur which interfaces into groove 213 at the top edge of the ID-channel. Contact point 117 (and 147) is a trough to interface with lower ID-channel ridge 217. End caps 140 are then secured by a screw 150 into provided screw mounts 119. End caps 140 also provide containment and restraint for connective wires which link the light sources 120, 130 to a power supply. Of note, the end caps 140 may firmly anchor wires to prevent accidental strain and pulling of said wires.

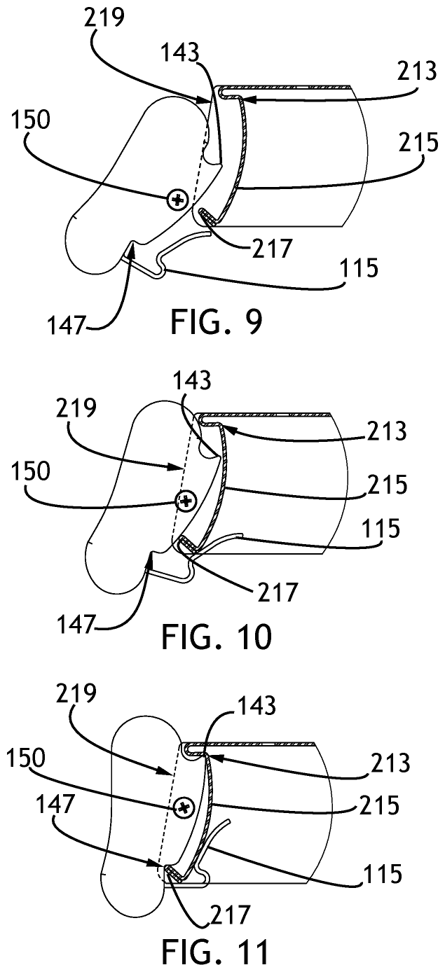

Installing the apparatus is shown in FIGS. 9-11. The assembled apparatus 110 is positioned at an angle underneath the merchandiser shelf, with the spring arm 115 proximate the lower ID-channel edge 217 (FIG. 9). The apparatus 110 is then rotated so that the spring arm 115 slides behind the ID-channel wall 215 (FIG. 10) until it snaps into place (FIG. 11) with the contact points 143, 147 fully engaged with ID-channel points 123, 127. Spring arm 115 grips and interacts with the back of the ID-channel 215 to further secure the apparatus 110. Meanwhile, the end cap securement screw 150 is rotated behind the side edge of the merchandiser shelf 219, hiding it from view. It should be noted that the installation of the apparatus is accomplished without the need for any tools, though tools may be developed or used if deemed more efficient.

The extrusion channel 110 and the associated spring arm 115 may be manufactured of any known and suitable material, with preferences for metals, polymers, and composites, and particular preference for polyvinyl chloride (PVC) as it is inexpensive, durable, light, and easily extruded. Spring arm 115 may take any form, but it is preferred to be a recurve projection from the aft of the extrusion channel 110 as this may be a simple feature included in an extrusion process. End caps 140 may also be manufactured of metals, polymers, or composites.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

1. A lighting apparatus for a merchandiser shelf, the merchandiser shelf comprising an ID-channel having a back wall, an upper groove, and a lower ridge, the lighting apparatus comprising:
an elongate extrusion channel having a front surface and a rear surface and a rearward lower interface trough;
a replacement ID-channel along the front surface of the extrusion channel, an upper rearward facing lighting trough and a lower rearward facing lighting trough, both of which containing at least one light source; and
a recurve spring arm extending rearwardly from a lower edge of the elongate extrusion channel from between the lower lighting trough and lower interface trough;
wherein the lighting apparatus is rotated about the lower ridge of the ID-channel allowing the recurve spring arm to extend behind and interface with the back wall of the ID channel.

2. The lighting apparatus of claim 1 further comprising and upper rearward spur which interfaces with the upper groove of the ID-channel.

3. (canceled)

4. (canceled)

5. The lighting apparatus of claim 1 further comprising two end caps fitted upon opposed sides of the elongate extrusion channel.

6. The lighting apparatus of claim 5 further comprising and upper rearward spur which interfaces with the upper groove of the ID-channel.

7. (canceled)

8. (canceled)
